(19) United States
(12) Patent Application Publication
(10) Pub. No.: US 2026/0270622 A1
(43) Pub. Date: Sep. 10, 2026

(54) A MICRO-ELECTROMECHANICAL-SYSTEM BASED MICRO SPEAKER

(71) Applicant: MYVOX AB, Stockholm (SE)

(72) Inventor: Josef HANSSON, Vällingby (SE)

(73) Assignee: MYVOX AB, Stockholm (SE)

(21) Appl. No.: 19/162,497

(22) PCT Filed: Feb. 13, 2024
(86) PCT No.: PCT/SE2024/050132

§ 371 Date: Sep. 5, 2025

(30) Foreign Application Priority Data
Mar. 14, 2023 (SE) 2350284-2

(51) Int. Cl. H04R 17/00; H04R 1/02; H04R 7/06

(52) U.S. Cl. CPC H04R 17/00; H04R 1/023; H04R 7/06; H04R 2201/003

(57) ABSTRACT

A MEMS-based micro speaker has at least one flexible cantilever attached to a support structure via at least one attachment section. The at least one flexible cantilever deflects relative to the support structure in response to control signals influencing piezoelectric actuators mechanically linked to the least one flexible cantilever. A flexible polymer membrane that prevents fluid leakage covers the at least one flexible cantilever and at least a portion of the support structure. The support structure surrounds an active area in which the at least one flexible cantilever is deflectable relative to the support structure. The at least one flexible cantilever has a meander-shaped outline, such that an extension thereof is longer than a shortest distance from the at least one attachment section to the center.

### TECHNICAL FIELD

The present invention relates generally to miniature-sized sound generators. Especially, the invention relates to a micro-electro-mechanical-system (MEMS) based micro speaker according to the preamble of claim 1.

### BACKGROUND

The vibration amplitude is a limiting factor for producing sound pressure from small membrane speakers. This is especially the case at lower frequencies. In general, a larger diaphragm diameter enables a given sound-pressure-level (SPL) at a smaller deflection amplitude. In other words, increased vibration amplitude allows for smaller speakers at the same level of performance.

For example, as described in Wang, H., et al., Review of Recent Development of MEMS Speakers, Micromachines 2021, 12, 1257, http://doi.org/10.3390/mi12101257 MEMS based micro speakers represent an emerging new technology. In this field, the piezoelectric MEMS micro speaker appear to be the most promising alternative. In its most basic configuration a piezoelectric MEMS micro speaker has a silicon membrane, which is obtained by etching a backside cavity from a silicon chip, and which is actuated by a piezoelectric layer on top of the membrane. The piezoelectric layer is capable to produce high forces. However, for this type of speaker, the vibration amplitude is limited by the tensile tension in the membrane. Moreover, silicon is a relatively stiff material, which also hampers the total amplitude. In practice, therefore, the maximum deflection of the speaker is limited by the stiffness of the silicon membrane. To increase the deflection, it is possible to create slits in the membrane. Inevitably, the slits cause air gaps in the membrane. As long as the slits are small, say under 5 μm, and the deflection is moderate, the acoustic leakage through the gaps is normally acceptable. However, the slits, as such, also pose a limitation on the maximum deflection attainable.

Increasing the deflection by creating slits in the membrane is described in the article Stoppel, A., et al., New integrated full-range MEMS speaker for in-ear applications, 2018 IEEE Micro Electro Mechanical Systems (MEMS), 2018, pp. 1068-1071, doi: 10.1109/MEMSYS.2018.8346744. This article discloses a type of powerful and fully integrated piezoelectric MEMS speaker for in-ear applications. Measurements performed on first prototypes using an artificial ear simulator have revealed a remarkable acoustic performance with respect to SPL, reproduction range, total harmonic distortion (THD) and electroacoustic sensitivity. Due to the mechanically decoupled design without a closed membrane, high SPL values of about 110 dB are achieved from 20 Hz to 20 kHz, exceeding the reproduction range of typical electrodynamic and balanced armature speakers. At the same time, the MEMS speakers feature a very flat frequency response, which has been realized by means of electronic equalization. With respect to the reproduction quality, the speakers are capable of delivering low THD of less than 2% for most frequencies. Moreover, electroacoustic sensitivity measurements have proven good energy efficiency with sensitivity values surpassing 110 dB/mW within almost the entire audible frequency range.

The above-mentioned air leakage may be avoided by the strategy for obtaining high sound-pressure-level MEMS speakers via a rigid-flexible vibration coupling mechanism of unsealed piezoelectric cantilevers and a sealed Parylene C membrane described in the article Q. Wang, Q., et al., Obtaining High SPL Piezoelectric MEMS Speaker via a Rigid-flexible Vibration Coupling Mechanism, Journal of Microelectromechanical Systems, Volume 30, No. 5, 2021, DOI: 10.1109/JMEMS.2021.3087718. Here, the speaker comprises six identical triangular vibration cantilevers elements arranged to form a regular hexagonal vibration membrane with a side length of 2 mm. The speaker has a PZT thin film layer and Pt layers as upper and lower electrodes; its elastic actuator layer is a SiO₂/Si/SiO₂/Si multilayer composite film, and its substrate is an SOI one. To form the rigid-flexible-coupling sealed vibration membrane, Parylene C is deposited on the vibration cantilever surfaces and the sidewalls and bottoms of the etched gaps before etching the back cavity. Compared with the SPL of the designed speaker with no deposited flexible Parylene C at a driving voltage of 2 V, the SPL produced by the speaker with the rigid-flexible-coupling sealed vibration membrane increased by 3-12.2 dB.

Thus, covering the piezoelectric cantilevers with a flexible polymer film that seals the vibration membrane to the surrounding side walls may improve the efficiency of a MEMS based speaker by some amount. However, this design approach is associated with its own shortcomings, for instance energy losses resulting from stretching the polymer film.

### SUMMARY

The object of the present invention is therefore to offer an energy-efficient MEMS based speaker that allows a high total membrane deflection and avoids acoustic leakages.

According to the invention, the object is achieved by a MEMS-based micro speaker containing a support structure, at least one flexible cantilever and a flexible polymer membrane. The at least one flexible cantilever is attached to the support structure via at least one attachment section and the at least one flexible cantilever is configured to be deflected relative to the support structure in response to at least one control signal influencing at least one piezoelectric actuator mechanically linked to the least one flexible cantilever. The flexible polymer membrane covers the at least one flexible cantilever and at least a portion of the support structure. The flexible polymer membrane is arranged to prevent fluid leakage between the at least one flexible cantilever and the support structure. The support structure surrounds an active area, with a general elliptic or polygonal outline, e.g. circular or rectangular, in which the at least one flexible cantilever is deflectable relative to the support structure. The at least one flexible cantilever has a meander-shaped outline, such that an extension thereof is longer than a shortest distance from the at least one attachment section to a center of the active area. Specifically, the extension is measured from the at least one attachment section along a shortest line on the at least one flexible cantilever to a central most part of the at least one flexible cantilever.

The above MEMS-based micro speaker is advantageous because the proposed meander-shape enables arranging comparatively long cantilevers in any given active area. This, in turn, allows for large end-deflection of each cantilever, which generally translates into a high attainable SPL.

According to one embodiment of the invention, the at least one flexible cantilever has a planar general spiral shaped outline when controlled by the at least one control signal to be parallel with the support structure, preferably including at least one segment with a curved outline and/or at least one segment with a rectilinear outline. Namely, thereby it is possible to make very good use of the active area regardless the shape thereof.

According to another embodiment of the invention, the speaker contains at least two flexible cantilevers arranged with their respective general spiral shaped outlines in a nested manner relative to one another. Consequently, the force that the flexible cantilevers exert on the flexible polymer membrane may be distributed evenly over the flexible polymer membrane at arbitrary magnitudes of deflection

According to yet another embodiment of the invention, the flexible polymer membrane is elastic and arranged over the at least one flexible cantilever and the support structure to stretch over the active area in response to deflecting the at least one flexible cantilever relative to the support structure. Thus, the flexible polymer membrane may accommodate substantial flexions of the flexible cantilevers at moderate energy losses.

According to still another embodiment of the invention, the flexible polymer membrane is arranged over the active area and the support structure, such that in a first positioning of the at least one flexible cantilever in response to at least one first signal value of the at least one control signal, the flexible polymer membrane is folded to form at least one fold between at least two segments of the at least one flexible cantilever. Furthermore, in a second positioning of the at least one flexible cantilever in response to at least one second signal value of the at least one control signal, the at least one fold is unfolded due to a deflection of the at least one flexible cantilever relative to the support structure. This arrangement is advantageous because it renders the energy losses lower than if, for example, the flexible polymer membrane was exclusively stretched in the second positioning.

According to further embodiments of the invention, the active area may contain at least one reactive portion being uncovered by the at least one flexible cantilever, which at least one reactive portion for example comprises the center of the active area. Thus, an overall movable mass of the speaker may be held low, which vouches for high energy-efficiency.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows a top view of a MEMS-based micro speaker according to a first embodiment of the invention;

FIG. 2 shows a top view of a MEMS-based micro speaker according to a second embodiment of the invention;

FIG. 3a shows a top view of a MEMS-based micro speaker according to a third embodiment of the invention;

FIGS. 3ba-c illustrate how the flexible polymer membrane may be arranged over the flexible cantilevers and the support structure according to embodiments of the invention;

FIG. 4 shows a top view of a MEMS-based micro speaker according to a fourth embodiment of the invention;

FIG. 5 shows a top view of a MEMS-based micro speaker according to a fifth embodiment of the invention;

FIG. 6 shows a top view of a MEMS-based micro speaker according to a sixth embodiment of the invention; and

FIG. 7 shows a top view of a MEMS-based micro speaker according to a seventh embodiment of the invention.

### DETAILED DESCRIPTION

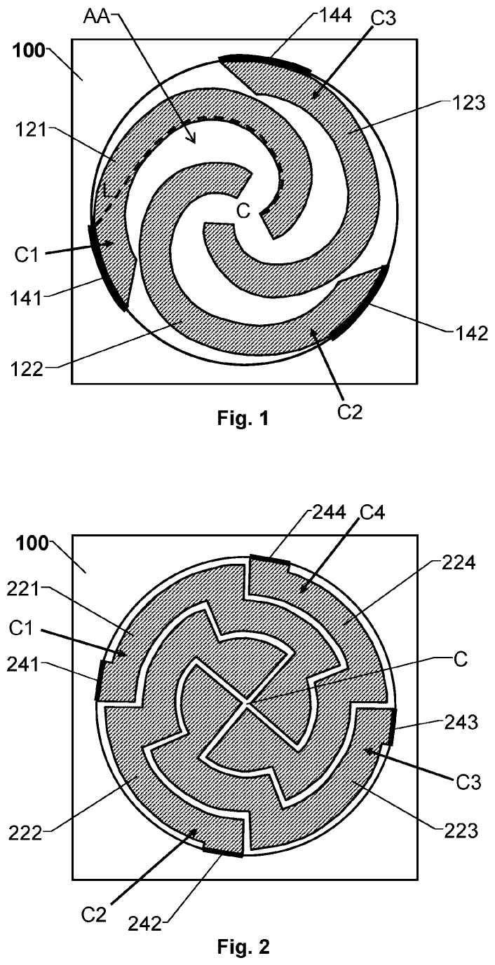

In FIG. 1a, we see a top view of a MEMS-based micro speaker according to a first embodiment of the invention.

The speaker includes a support structure 100, three flexible cantilevers 121, 122 and 123 respectively and a flexible polymer membrane (not shown). The flexible cantilevers 121, 122 and are attached to the support structure 100 via a respective attachment section 141, 142 and 142. Each of the flexible cantilevers 121, 122 and 123 is configured to be deflected relative to the support structure 100 in response to at least one control signal C1, C2 and C3 respectively influencing a respective piezoelectric actuator (not shown), which is mechanically linked to each of the flexible cantilevers 121, 132 and 123.

The flexible polymer membrane (not shown) covers the flexible cantilevers 121, 122 and 123 and at least a portion of the support structure 100. The flexible polymer membrane is arranged to prevent fluid leakage between the flexible cantilevers 121, 122 and 123 and the support structure 100. The support structure 100 surrounds an active area AA, which here has a circular shape, and in which active area AA the flexible cantilevers 121, 122 and 123 are deflectable relative to the support structure 100. The flexible polymer membrane is preferably elastic, and is preferably arranged over the flexible cantilevers 121, 122 and 123 and the support structure 100 to stretch over the active area AA in response to deflecting the flexible cantilevers 121, 122 and 123 relative to the support structure 100.

In the embodiment of the invention illustrated in FIG. 1, the flexible cantilevers 121, 122 and 123 are arranged such that some portions of the active area AA are uncovered. In this disclosure we refer to these portions as reactive portions of the active area AA.

Specifically, each of the flexible cantilevers 121, 122 and 123 has a meander-shaped outline. In the embodiment of FIG. 1, this means that each of the flexible cantilevers 121, 122 and 123 contains a respective segment with a curved outline, have a respective planar general spiral shaped outline when controlled by the control signals C1, C2 and C3 respectively to be parallel with the support structure, and are arranged with their respective general spiral shaped outlines in a nested manner relative to one another. As a result, when the flexible cantilevers 121, 122 and 123 are caused to be deflected relative to the support structure 100, the forces that the flexible cantilevers 121, 122 and 123 exert on the flexible polymer membrane are distributed evenly over the active area AA.

In this disclosure, the term “planar” in the wording “planar general spiral shaped outline” is understood to mean that the profile of each of the flexible cantilevers varies up or down from a fully flat profile by less than +/−5% of a maximal extension/diameter of the flexible polymer membrane along a plane being parallel to a top surface of the support structure 100.

Moreover, the flexible cantilevers 121, 122 and 123 have respective lengths such that an extension of each flexible cantilever is longer than a shortest distance from the attachment section 141, 142 and 142 respectively to a center C of the active area AA. Here, the extension is measured from the attachment section along a shortest line on the flexible cantilever to a central most part of the flexible cantilever, as exemplified by a line L from the attachment section 141 to a point of the flexible cantilever 121 at an end thereof being opposite to the attachment section 141.

FIG. 2 shows a top view of a MEMS-based micro speaker according to a second embodiment of the invention.

Here, four flexible cantilevers 221, 222, 223 and 224 respectively are attached to a support structure 100 via a respective attachment section 241, 242, 243 and 244. The flexible cantilevers 221, 222, 223 and 224 are configured to be deflected relative to the support structure 100 in response to control signals C1, C2, C3 and C4 respectively influencing a respective piezoelectric actuator (not shown) mechanically linked to each of the flexible cantilevers 221, 222, 223 and 224.

The support structure 100 surrounds an active area AA in which the flexible cantilevers 221, 222, 223 and 224 are deflectable relative to the support structure 100. A flexible polymer membrane (not shown) covers the flexible cantilevers 221, 222, 223 and 224 and at least a portion of the support structure 100 in such a manner that fluid leakage between the flexible cantilevers 221, 222, 223 and 224 and the support structure 100 is prevented.

Analogous to the above, the flexible cantilevers 221, 222, 223 and 224 have meander-shaped outlines such that an extension of each of them is longer than a shortest distance from the respective attachment section 241, 242, 243 and 244 to a center C of the active area AA, where said extension is measured from the attachment section 241, 242, 243 and 244 respectively along a shortest line on the flexible cantilever to a central most part of this flexible cantilever.

In the embodiment of FIG. 2, each of the flexible cantilevers 221, 222, 223 and 224 has a planar general spiral shaped outline when controlled by the control signals C1, C2, C3 and C4 to be parallel with the support structure 100. Each of the flexible cantilevers 221, 222, 223 and 224 contains segments with a mix of curved and rectilinear outlines, which are arranged with their respective general spiral shaped outlines in a nested manner relative to one another. As exemplified in FIG. 2, this allows for filling the active area AA by the flexible cantilevers 221, 222, 223 and 224 efficiently. Consequently the flexible polymer membrane may be controlled to move in a highly precise manner at comparatively low energy losses.

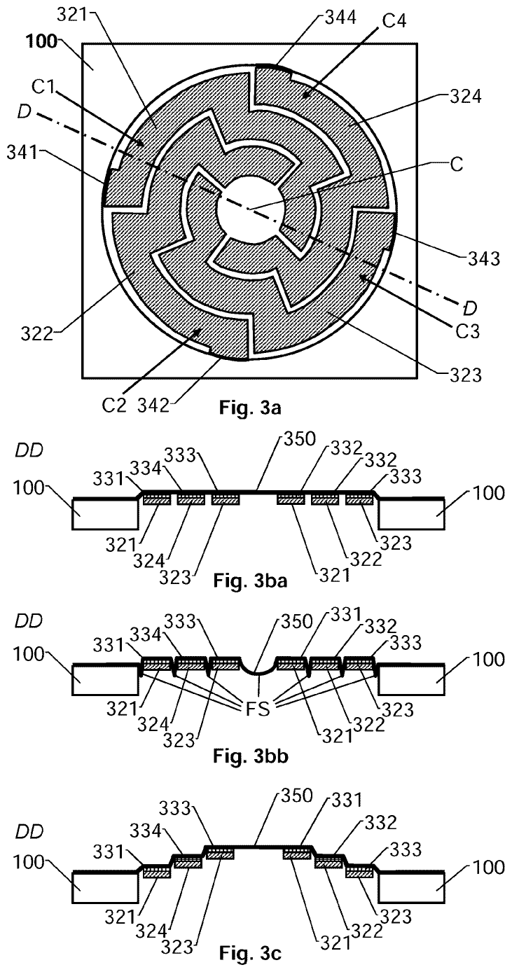

FIG. 3a shows a top view of a MEMS-based micro speaker according to a third embodiment of the invention.

Also here, four flexible cantilevers 321, 322, 323 and 324 respectively are attached to a support structure 100 via a respective attachment section 341, 342, 343 and 344, and each of the flexible cantilevers 321, 322, 323 and 324 is configured to be deflected relative to the support structure 100 in response to a respective control signal C1, C2, C3 and C4 influencing a piezoelectric actuator (not shown in FIG. 3a) mechanically linked to the respective flexible cantilever 321, 322, 323 and 324.

Analogous to the above, a flexible polymer membrane (not shown in FIG. 3a) covers the flexible cantilevers 321, 322, 323 and 324 and at least a portion of the support structure 100. The flexible polymer membrane is arranged to prevent fluid leakage between the flexible cantilevers 321, 322, 323 and 324 and the support structure 100. The support structure 100 surrounds an active area AA in which the flexible cantilevers 321, 322, 323 and 324 are deflectable relative to the support structure 100.

Similar to the embodiment of FIG. 2, in the embodiment of FIG. 3, each of the flexible cantilevers 321, 322, 323 and 324 has a planar general spiral shaped outline when controlled by the control signals C1, C2, C3 and C4 to be parallel with the support structure 100, each of the flexible cantilevers 321, 322, 323 and 324 contains segments with a mix of curved and rectilinear outlines, which are arranged with their respective general spiral shaped outlines in a nested manner relative to one another that allows for filling the active area AA. However, here, similar to the embodiment of FIG. 1, the active area AA contains a reactive portion being uncovered by the flexible cantilevers 321, 322, 323 and 324.

For balance, it is generally beneficial if the reactive portion is arranged symmetrically the active area AA, for example so that the reactive portion comprises the center C of the active area AA, as illustrated in FIG. 3a.

In any case, each of the flexible cantilevers 321, 322, 323 and 324 has a meander-shaped outline such that a respective extension thereof is longer than a shortest distance from the attachment section 341, 342, 343 and 344 respectively to a center C of the active area AA, which extension is measured from the attachment section attachment section 341, 342, 343 and 344 along a shortest line on the at least one flexible cantilever 321, 322, 323 and 324 to a central most part of the at least one flexible cantilever 321, 322, 323 and 324.

Further, each of the flexible cantilevers 321, 322, 323 and 324 preferably has a planar general spiral shaped outline when controlled by the respective control signal C1, C2, C3 and C4 to be parallel with the support structure 100. For the same reasons as above, it is also advantageous if the flexible cantilevers 321, 322, 323 and 324 are arranged with their respective general spiral shaped outlines in a nested manner relative to one another.

FIGS. 3ba, 3bb and 3c show cross section views along a line DD in FIG. 3a, where the flexible cantilevers 321, 322, 323 and 324 have been controlled by the control signals C1, C2, C3 and C4 to attain different deflections relative to the support structure 100.

FIG. 3ba shows a set of piezoelectric actuators, where a respective piezoelectric actuator 331, 332, 333 and 334 is mechanically linked to each of the flexible cantilevers 321, 322, 323 and 324, and a flexible polymer membrane 350 covers the flexible cantilevers 321, 322, 323 and 324 and at least a portion of the support structure 100 so that leakage of fluid, e.g. air, is prevented between the flexible cantilevers 321, 322, 323 and 324 and the support structure 100.

In particular, FIG. 3ba illustrates a first positioning of the flexible cantilevers 321, 322, 323 and 324 attained in response to at least one first signal value of the control signals C1, C2, C3 and C4 received by the piezoelectric actuators 331, 332, 333 and 334. The flexible polymer membrane 350 is arranged over the active area AA such that, in the first positioning, the flexible polymer membrane 350 is essentially without folds or creases.

FIG. 3bb illustrates the first positioning of the flexible cantilevers 321, 322, 323 and 324 according to another embodiment of the invention. Here, the flexible polymer membrane 350 is arranged over the active area AA such that the flexible polymer membrane 350 is folded to form a respective fold FS between each segment of the flexible cantilevers 321, 322, 323 and 324.

The flexible polymer membrane 350 may also form a slack, or a have trough profile, over the reactive portion.

FIG. 3c illustrates a second positioning of the flexible cantilevers 321, 322, 323 and 324 attained in response to at least one second signal value of the control signals C1, C2, C3 and C4 received by the piezoelectric actuators 331, 332, 333 and 334.

For instance, the first positioning may represent a first extreme position of the flexible cantilevers 321, 322, 323 and 324 and the second positioning may represent a second extreme position of the flexible cantilevers 321, 322, 323 and 324.

Starting from the first positioning exemplified in FIG. 3bb and controlling the flexible cantilevers 321, 322, 323 and 324 to the second positioning of FIG. 3c, causes the at least one fold FS to be unfolded due to a deflection of the flexible cantilevers 321, 322, 323 and 324 relative to the support structure 100, whereas starting from the first positioning exemplified in FIG. 3ba and controlling the flexible cantilevers 321, 322, 323 and 324 to the second positioning of FIG. 3c, causes the flexible polymer membrane 350 exclusively to stretch. The latter is typically associated with an amount of energy losses, which renders the former somewhat better from an energy-conservation point-of-view. However, this design is also slightly more complex to implement. It should be noted that, according to embodiments of the invention, one or more of the control signals may contain a positive or negative DC bias level, which sets a reference, or zero level, for the flexible cantilevers to any position between first and second extreme positions.

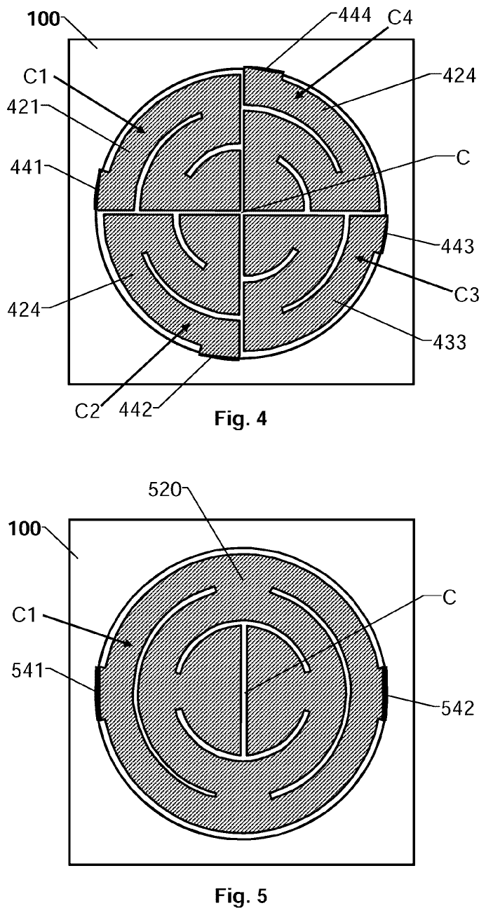

FIG. 4 shows a top view of a MEMS-based micro speaker according to a fourth embodiment of the invention.

Again, four flexible cantilevers 421, 422, 423 and 424 are attached to a support structure 100 via a respective attachment section 441, 442, 443 and 444, and each of flexible cantilevers 421, 422, 423 and 424 is configured to be deflected relative to the support structure 100 in response to a respective control signal C1, C2, C3 and C4 influencing a piezoelectric actuator mechanically linked to it.

A flexible polymer membrane (not shown) covers the flexible cantilevers 421, 422, 423 and 424 and at least a portion of the support structure 100 so that leakage of fluid, e.g. air, is prevented between the flexible cantilevers 421, 422, 423 and 424 and the support structure 100. An active area AA is surrounded by the support structure 100, and the flexible cantilevers 421, 422, 423 and 424 are deflectable relative to the support structure 100 within the active area AA.

Each of the flexible cantilevers 421, 422, 423 and 424 has a meander-shaped outline such that an extension thereof is longer than a shortest distance from the respective attachment section 441, 442, 443 and 444 to a center C of the active area AA. Analogous to the above, said extension is measured from the attachment section 441, 442, 443 and 444 along a shortest line on the flexible cantilever 421, 422, 423 and 424 to a central most part of the flexible cantilever in question.

Preferably, each of the flexible cantilevers 421, 422, 423, 424 has a planar general spiral shaped outline when controlled by the respective control signal C1, C2, C3 and C4 to be parallel with the support structure.

In the embodiment of FIG. 4, each of the flexible cantilevers 421, 422, 423 and 424 contains segments with a mix of curved and rectilinear outlines, which are arranged with their respective general spiral shaped outlines in a nested manner relative to one another that fills the entire the active area AA.

FIG. 5 shows a top view of a MEMS-based micro speaker according to a fifth embodiment of the invention.

Here, a single flexible cantilever 520 is attached to a support structure 100 via two attachment sections 541 and 542 respectively, which flexible cantilever 520 covers an entire active area AA that is surrounded by the support structure 100.

Analogous to the above embodiments, the flexible cantilever 520 is configured to be deflected relative to the support structure 100 in response to a control signal C1 influencing a piezoelectric actuator (not shown) being mechanically linked to the flexible cantilever 520. Moreover, a flexible polymer membrane (not shown) covers the flexible cantilever 520 and at least a portion of the support structure 100. The flexible polymer membrane is arranged to prevent fluid leakage between the flexible cantilever 510 and the support structure 100.

Further, the flexible cantilever 520 has a meander-shaped outline such that an extension thereof is longer than a shortest distance from the attachment sections 541 or 542 to a center C of the active area AA. In this embodiment, this means that a set of cuts and slits are arranged in the flexible cantilever 520 in such a manner that if a line, analogous to the line L in FIG. 1, is drawn from any of the attachment sections 541 or 542 to the center C without crossing any of the cuts or slits, this line is longer than the shortest distance from the attachment section in question to the center C.

It is advantageous if the flexible cantilever 520 contains at least one segment with a curved outline and/or at least one segment with a rectilinear outline, for example as illustrated in FIG. 5.

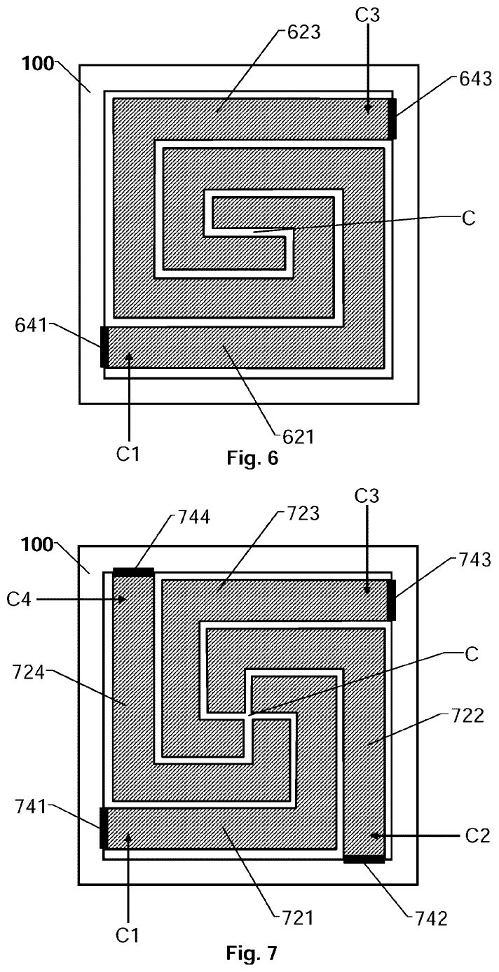

FIG. 6 shows a top view of a MEMS-based micro speaker according to a sixth embodiment of the invention.

In this embodiment, two flexible cantilevers 621 and 622 are attached to a support structure 100 via a respective attachment section 641 and 642. Each of the flexible cantilevers 621 and 622 respectively is configured to be deflected relative to the support structure 100 in response to control signals C1 and C2 influencing a respective piezoelectric actuator (not shown) mechanically linked to each of the flexible cantilevers 621 and 622. A flexible polymer membrane (not shown) covers the flexible cantilevers 621 and 622 and at least a portion of the support structure 100, so that fluid, e.g. air, is prevented from leaking between the flexible cantilevers 621 and 622 and the support structure 100. The support structure 100, in turn, surrounds an active area AA in which the flexible cantilevers 621 and 622 are deflectable relative to the support structure 100.

The flexible cantilevers 621 and 622, which here exclusively contains segments with rectilinear outlines, have meander-shaped outlines and, as discussed above, a respective extension thereof is longer than a shortest distance from the attachment section 641 and 642 to a center C of the active area AA.

Preferably, each of the flexible cantilevers 621 and 622 has a planar general spiral shaped outline when controlled by the control signals C1 and C2 respectively to be parallel with the support structure 100.

It is further advantageous if the flexible cantilevers 621 and 622 are arranged with their respective general spiral shaped outlines in a nested manner relative to one another, for example as illustrated in FIG. 6.

FIG. 7 shows a top view of a MEMS-based micro speaker according to a seventh embodiment of the invention.

Here, four flexible cantilevers 721, 722, 723 and 724 are attached to a support structure 100 via a respective attachment section 741, 742, 743 and 744. Again, each of the flexible cantilevers 721, 722, 723 and 724 is configured to be deflected relative to the support structure 100 in response to a respective control signal C1, C2, C3 and C4 influencing piezoelectric actuators (not shown) mechanically linked to the respective flexible cantilever 721, 722, 723 and 724. A flexible polymer membrane (not shown) covers the flexible cantilevers 721, 722, 723 and 724 and at least a portion of the support structure 100. The flexible polymer membrane is arranged to prevent leakage of fluid, e.g. air or water, between the flexible cantilevers 721, 722, 723 and 724 and the support structure 100. The support structure 100 surrounds an active area AA in which the flexible cantilevers 721, 722, 723 and 724 are deflectable relative to the support structure 100.

Analogous to the above, each of the flexible cantilevers 721, 722, 723 and 724 has a meander-shaped outline, such that an extension thereof is longer than a shortest distance from the respective attachment section 741, 742, 743 and 744 to a center C of the active area AA, where said extension is measured from the respective flexible cantilever 741, 742, 743 and 744 in question along a shortest line on this flexible cantilever 721, 722, 723 or 724 to a central most part thereof.

Similar to the embodiment shown in FIG. 6, in the embodiment of FIG. 7, each of the flexible cantilevers 721, 722, 723 and 724 contains segments with a rectilinear outlines only.

Desirably, each of the flexible cantilevers 721, 722, 723 and 724 has a planar general spiral shaped outline when controlled by the control signals C1, C2, C3 and C4 respectively to be parallel with the support structure 100.

It is further advantageous if the flexible cantilevers 721, 722, 723 and 724 are arranged with their respective general spiral shaped outlines in a nested manner relative to one another.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A MEMS-based micro speaker comprising:
a support structure;
at least one flexible cantilever attached to the support structure via at least one attachment section, which at least one flexible cantilever is configured to be deflected relative to the support structure in response to at least one control signal influencing at least one piezoelectric actuator mechanically linked to the least one flexible cantilever; and
a flexible polymer membrane covering the at least one flexible cantilever and at least a portion of the support structure, which flexible polymer membrane is arranged to prevent fluid leakage between the at least one flexible cantilever and the support structure,
wherein the support structure surrounds an active area in which the at least one flexible cantilever is deflectable relative to the support structure, and
wherein the at least one flexible cantilever has a meander-shaped outline such that an extension thereof is longer than a shortest distance from the at least one attachment section to a center of the active area, which extension is measured from the at least one attachment section along a shortest line on the at least one flexible cantilever to a central most part of the at least one flexible cantilever.

2. The MEMS-based micro speaker according to claim 1, wherein the at least one flexible cantilever has a planar general spiral shaped outline when controlled by the at least one control signal to be parallel with the support structure.

3. The MEMS-based micro speaker according to claim 1, wherein the at least one flexible cantilever comprises at least one segment with a curved outline.

4. The MEMS-based micro speaker according to claim 1, wherein the at least one flexible cantilever comprises at least one segment with a rectilinear outline.

5. The MEMS-based micro speaker according to claim 2, comprising at least two flexible cantilevers arranged with their respective general spiral shaped outlines in a nested manner relative to one another.

6. The MEMS-based micro speaker according to claim 1, wherein the flexible polymer membrane is elastic, and the flexible polymer membrane is arranged over the at least one flexible cantilever and the support structure to stretch over the active area in response to deflecting the at least one flexible cantilever relative to the support structure.

7. The MEMS-based micro speaker according to claim 1, wherein the flexible polymer membrane is arranged over the active area and the support structure such that:
in a first positioning of the at least one flexible cantilever in response to at least one first signal value of the at least one control signal, the flexible polymer membrane is folded to form at least one fold between at least two segments of the at least one flexible cantilever; and
in a second positioning of the at least one flexible cantilever in response to at least one second signal value of the at least one control signal, the at least one fold is unfolded due to a deflection of the at least one flexible cantilever relative to the support structure.

8. The MEMS-based micro speaker according to clam 1, wherein the active area comprises at least one reactive portion being uncovered by the at least one flexible cantilever.

9. The MEMS-based micro speaker according to claim 8, wherein at least one of the at least one reactive portion comprises the center of the active area.

10. The MEMS-based micro speaker according to claim 1, wherein the active area has a general elliptic outline.

11. The MEMS-based micro speaker according to claim 1, wherein the active area has a general polygonal outline.

12. The MEMS-based micro speaker according to claim 1, wherein the at least one flexible cantilever comprises at least one segment with a curved outline.

13. The MEMS-based micro speaker according to claim 1, wherein the at least one flexible cantilever comprises at least one segment with a rectilinear outline.
